(19) United States
(12) Patent Application Publication
(10) Pub. No.: US 2025/0214882 A1
(43) Pub. Date: Jul. 3, 2025

(54) METHOD FOR PRODUCING OPTICAL FIBER

(71) Applicant: SUMITOMO ELECTRIC INDUSTRIES, LTD., Osaka-shi, Osaka (JP)

(72) Inventors: Yuzuki KOBAYASHI, Osaka-shi, Osaka (JP); Shinji NAKAHARA, Osaka-shi, Osaka (JP); Yasuhiro OHASHI, Osaka-shi, Osaka (JP)

(21) Appl. No.: 18/851,926

(22) PCT Filed: Mar. 30, 2023
(86) PCT No.: PCT/JP2023/013102

§ 371 Date: Sep. 27, 2024

(30) Foreign Application Priority Data
Mar. 31, 2022 (JP) 2022-058765

(51) Int. Cl. C03B 37/07

(52) U.S. Cl. CPC C03B 37/07; C03B 2205/40

(57) ABSTRACT

A method for producing an optical fiber. The method includes drawing an optical-fiber base material while heating and softening the optical-fiber base material to produce a part of the optical fiber to be a product, and determining whether a predetermined condition is satisfied to determine a drawing end of the optical fiber that is to be a product from the optical-fiber base material. In the drawing, a linear speed for drawing the optical fiber is controlled with a target value of the linear speed constant. In the determining, when the linear speed is decreased by a predetermined amount from the target value, the drawing end of the optical fiber is determined.

### TECHNICAL FIELD

The present disclosure relates to a method for producing an optical fiber.

The present application claims priority based on Japanese Patent Application No. 2022-058765 filed on Mar. 31, 2022, and incorporates all the contents described in the Japanese Application.

### BACKGROUND ART

In the related art, an optical fiber has been produced by drawing an optical-fiber base material while heating and softening the optical-fiber base material. The optical-fiber base material includes an effective portion that can be used as a product and an ineffective portion located at an end of the effective portion, and Patent Literature 1 discloses a method for determining that the ineffective portion of the optical-fiber base material is reached based on a rapid change in a linear speed at which the optical fiber is drawn when the optical fiber is produced by drawing while heating and softening the optical-fiber base material.

In Patent Literature 1, when the optical fiber is drawn while maintaining the linear speed constant, the linear speed decreases, and immediately thereafter, the linear speed rapidly increases due to reaction. When the rapid increase in the linear speed is detected, it is determined that the ineffective portion of the optical-fiber base material is reached, and the drawing of the optical fiber is ended.

### CITATION LIST

### Patent Literature

Patent Literature 1: JP2010-13328A

### SUMMARY OF INVENTION

A method for producing an optical fiber of the present disclosure includes a drawing step of drawing an optical-fiber base material while heating and softening the optical-fiber base material to produce a part of the optical fiber to be a product; and a drawing end determination step of determining whether a predetermined condition is satisfied to determine a drawing end of the optical fiber that is to be a product from the optical-fiber base material, in the drawing step, a linear speed for drawing the optical fiber is controlled with a target value of the linear speed constant, and in the drawing end determination step, when the linear speed is decreased by a predetermined amount from the target value, the drawing end of the optical fiber is determined.

### BRIEF DESCRIPTION OF DRAWINGS

FIG. 1 is a schematic configuration diagram of an optical fiber producing apparatus capable of performing a method for producing an optical fiber according to an aspect of the present disclosure.

FIG. 2 is a block diagram of a control device in the optical fiber producing apparatus of FIG. 1.

FIG. 3 is a schematic diagram of an optical-fiber base material.

FIG. 4 is a graph of a linear speed for drawing the optical fiber.

### DESCRIPTION OF EMBODIMENTS

### Technical Problem

Depending on a difference in glass viscosity of a joint portion between core glass of the effective portion and core glass of the ineffective portion of the optical-fiber base material, a fusion state of the optical-fiber base material changes, the glass fusion rapidly proceeds, and a drawing speed of the optical fiber may rapidly increase. When the glass fusion rapidly proceeds as described above, in the method described in Patent Literature 1, since it is determined that the ineffective portion of the optical-fiber base material is reached based on the rapid increase in the linear speed, there is a problem that the rapid increase of the linear speed continues at a drawing end of the optical fiber.

An object of the present disclosure is to provide a method for producing an optical fiber capable of quickly determining that an effective portion of an optical-fiber base material is switched to an ineffective portion, and preventing a rapid increase in a linear speed even at a drawing end of the optical fiber.

### Advantageous Effects of Present Disclosure

According to the present disclosure, it is possible to quickly determine that an effective portion of the optical-fiber base material is switched to an ineffective portion, and prevent a rapid increase in the linear speed even at a drawing end of the optical fiber.

### DESCRIPTION OF EMBODIMENTS OF PRESENT INVENTION

First, the contents of an embodiment of the present disclosure will be listed and described.

The present disclosure achieves the following effects according to configurations of (1) to (5).
(1) A method for producing an optical fiber, includes a drawing step of drawing an optical-fiber base material while heating and softening the optical-fiber base material to produce a part of the optical fiber to be a product; and a drawing end determination step of determining whether a predetermined condition is satisfied to determine a drawing end of the optical fiber that is to be a product from the optical-fiber base material, in the drawing step, a linear speed for drawing the optical fiber is controlled with a target value of the linear speed constant, and in the drawing end determination step, when the linear speed is decreased by a predetermined amount from the target value, the drawing end of the optical fiber is determined.

According to the method for producing an optical fiber configured as above, it is possible to quickly determine that an effective portion of the optical-fiber base material is switched to an ineffective portion, and to prevent the linear speed from continuously increasing rapidly even at a drawing end of the optical fiber.
(2) In the above method for producing an optical fiber, the optical-fiber base material includes an effective portion that is a central portion in a longitudinal direction and that includes a core, and an ineffective portion that is an end portion in the longitudinal direction and that includes no core, and in the drawing end determination step, the drawing end of the optical fiber is determined further in consideration of a remaining length of the effective portion of the optical-fiber base material.

Accordingly, since it is possible to more reliably determine that the effective portion of the optical-fiber base material is switched to the ineffective portion, the drawing can be performed at a stable linear speed even at the drawing end of the optical fiber, and it is possible to more accurately grasp when the effective portion of the optical-fiber base material is switched to the ineffective portion, without being affected by noise or the like, so that core glass of the effective portion of the optical-fiber base material can be used up without waste.
(3) In the above method for producing an optical fiber, in the drawing end determination step, a condition for determining the drawing end of the optical fiber is determined based on a decrease amount of the linear speed of the optical-fiber base material drawn in the past and an inspection result of the optical fiber obtained from the optical-fiber base material.

Accordingly, since the condition for determining the drawing end can be set based on the inspection result of the optical fiber from the past drawing, the drawing end can be accurately determined according to specifications of the optical fiber producing apparatus to be used, specifications of the optical fiber, various producing conditions, and the like.
(4) In the above method for producing an optical fiber, in the drawing step, by controlling at least one of a feeding amount of the optical-fiber base material, an output of a heating element of a heating furnace for heating the optical-fiber base material, a speed of a capstan, or a speed of a winding-up bobbin, the linear speed for drawing the optical fiber is controlled with the target value of the linear speed constant.

Accordingly, since the linear speed for drawing the optical fiber in the effective portion of the optical-fiber base material is stabilized following the constant target value, a decrease in the linear speed at the drawing end can be reliably detected, and the drawing end can be more accurately determined.
(5) In the above method for producing an optical fiber, the predetermined decrease amount of the linear speed for determining the drawing end of the optical fiber in the drawing end determination step is set between 0.5% to 3% of the target value.

Accordingly, a range for setting the predetermined decrease amount of the linear speed for determining the drawing end of the optical fiber with respect to the constant target value of the linear speed for drawing the optical fiber in the effective portion of the optical-fiber base material can be specified, and the condition for determining the drawing end is appropriately set. Further, by setting an upper limit and a lower limit of the predetermined decrease amount of the linear speed for determining the drawing end of the optical fiber with respect to the constant target value of the linear speed for drawing the optical fiber in the effective portion of the optical-fiber base material, erroneous setting when the condition for determining the drawing end is set can be prevented.

### DETAILS OF EMBODIMENT OF PRESENT DISCLOSURE

Hereinafter, a specific example of a method for producing an optical fiber according to the present disclosure will be described.

In the following description, configurations denoted by the same reference numerals in different drawings are the same, and description thereof may be omitted.

The present disclosure is not limited to these exemplifications, but is indicated by the scope of claims, and is intended to include all modifications within a scope and meaning equivalent to the scope of claims.

### Embodiment 1

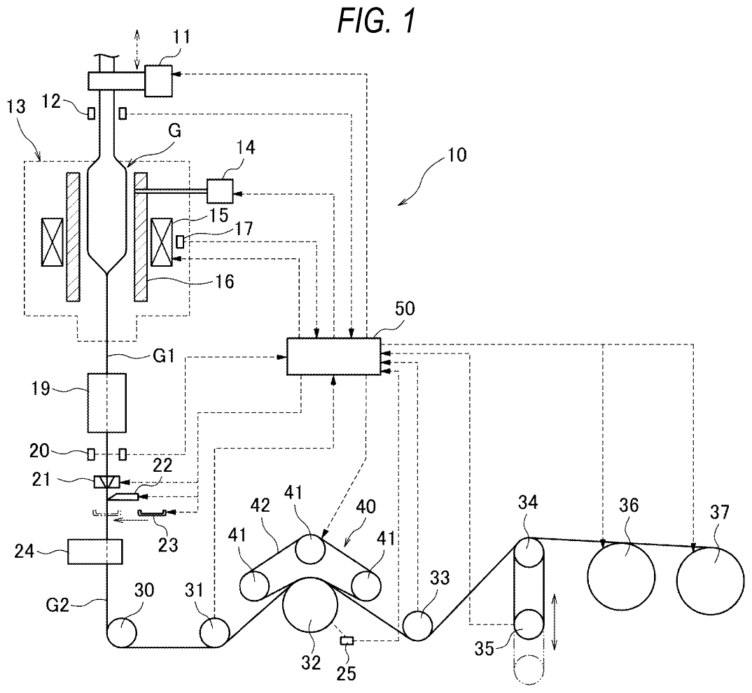

A method for producing an optical fiber according to Embodiment 1 of the present disclosure will be described with reference to FIGS. 1 to 4. First, an optical fiber producing apparatus 10 capable of performing an optical fiber producing method according to the present embodiment will be described with reference to FIG. 1. FIG. 1 is a schematic configuration diagram of the optical fiber producing apparatus 10 capable of performing the method for producing an optical fiber.

As shown in FIG. 1, the optical fiber producing apparatus 10 includes a vertical heating furnace 13 configured to heat an optical-fiber base material G, a feeding device 11 configured to feed the optical-fiber base material G to the heating furnace 13, a base material 10 feeding detector 12 configured to measure a feeding amount of the optical-fiber base material G, a cooling device 19 configured to cool a glass fiber G1 after being drawn, an outer diameter measuring device 20 configured to measure an outer diameter of the glass fiber G1, a die 21 configured to coat an ultraviolet curable resin around the glass fiber G1, an ultraviolet irradiation device 24 configured to cure the ultraviolet curable resin coated on an optical fiber G2 that is coated by the die 21, a tension meter 31 configured to measure a tension of the coated optical fiber G2, a capstan 40 configured to take up the optical fiber G2 via a guide roller 30, a first winding-up bobbin 36 and a second winding-up bobbin 37 configured to wind up the optical fiber G2 drawn by the capstan 40 via a dancer roller 34, and a control device 50.

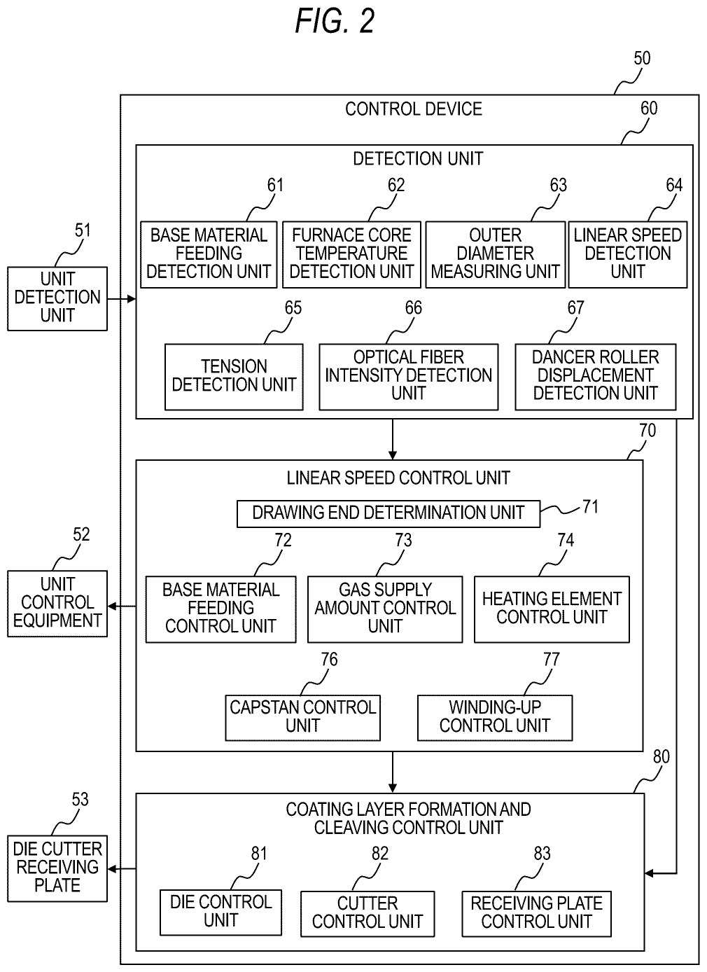

As shown in FIG. 2, the control device 50 is configured to control unit control equipments 52, 53 of the optical fiber producing apparatus 10, based on detection signals from a unit detector 51, thereby performing control to adjust respective producing steps of the optical fiber producing apparatus 10 for producing the optical fiber G2 of target specifications and setting a linear speed of the optical fiber G2 to a target value. As to be described later, the control device 50 includes a drawing end determination unit 71 configured to determine a predetermined drawing end condition of the optical fiber G2. The target specification of the optical fiber G2 to be produced is set by a target specification setting unit (not shown) of the control device 50.

The heating furnace 13 includes a cylindrical furnace core tube 16 into which the optical-fiber base material G is supplied, and a heating element 15 configured to heat the furnace core tube 16. The furnace core tube 16 is heated by the heating element 15 to form a heating space in a space inside the furnace core tube 16. The heating space is a space of a temperature at which glass of the optical-fiber base material G can be softened and drawn. The heating space is not particularly limited, but is adjusted to a predetermined value of, for example, 1800° C. or higher by controlling an output of the heating element 15 according to a control command from the control device 50. The heating furnace 13 is provided with a gas supply unit 14 configured to control a supply amount of a purge gas such as helium or nitrogen to the heating space, according to a control command from the control device 50.

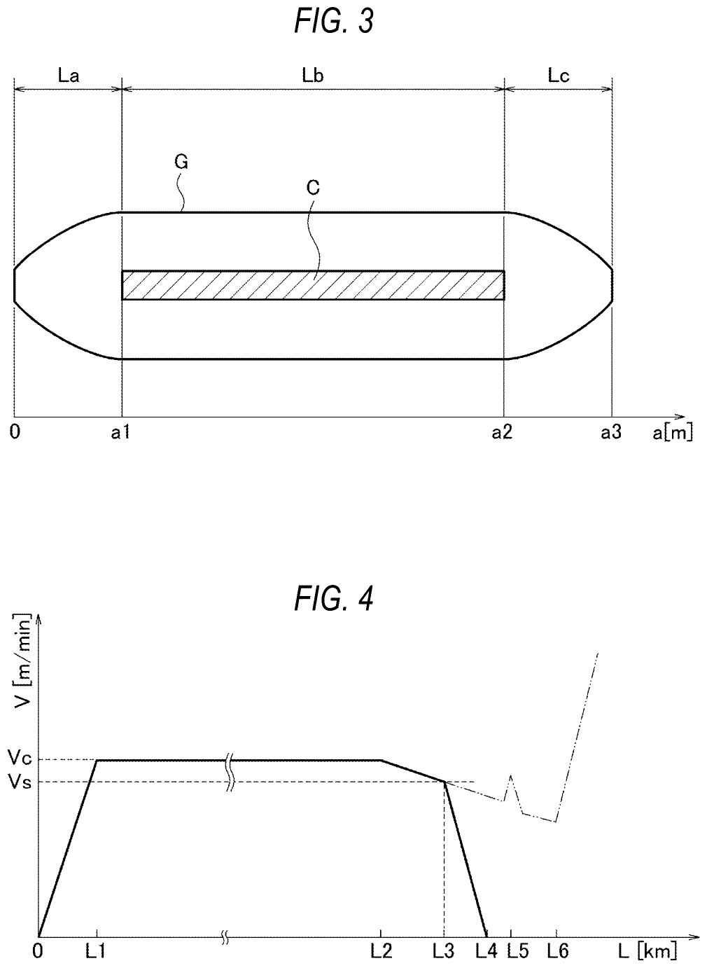

The feeding device 11 is configured to grip an upper portion of the optical-fiber base material G, that is, an end portion side on a Lc side in FIG. 3, and is configured to control the feeding amount of the optical-fiber base material G into the heating furnace 13 according to a control command from the control device 50 such that a lower end portion of the optical-fiber base material G, that is, an end portion on an La side in FIG. 3 is located in the heating space inside the furnace core tube 16. From a lower end of the heating furnace 13, a glass heated and fused in the heating space is drawn out as a thin glass fiber G1. The feeding device 11 is provided with the base material feeding detector 12 for measuring the feeding amount of the optical-fiber base material G, a remaining amount of the optical-fiber base material G, and the like. The heating furnace 13 is provided with a temperature detector 17 for measuring a temperature of a heating region in the furnace core tube 16. A measured value of the feeding amount of the optical-fiber base material G from the base material feeding detector 12 and a measured value of the temperature of the heating region from the temperature detector 17, are sent to the control device 50. The remaining amount of the optical-fiber base material G is calculated by the control device 50, based on an effective portion length Lb of the optical-fiber base material G and the measured value of the feeding amount.

The cooling device 19 is provided downstream the heating furnace 13, and the glass fiber G1 coming out of the heating furnace 13 is cooled by the cooling device 19. The cooling device 19 is formed of a main body portion including two members divided in a circumferential direction of the glass fiber G1, and the main body portion can be opened by separating the two divided members in a radial direction. Normally, the two divided members are engaged and used as a single unit. The main body portion of the cooling device 19 is provided with an insertion hole through which the glass fiber G1 is inserted in an axial direction. The glass fiber G1 is cooled by feeding a cooling gas into the insertion hole. A cooling flow path is formed along the axial direction inside the main body portion of the cooling device 19, and a cooling fluid is circulated inside the cooling flow path. The cooling gas in the insertion hole is cooled by the cooling fluid, and the glass fiber G1 is inserted through a cooling gas atmosphere, and the drawn glass fiber G1 is rapidly cooled from a high temperature to near a room temperature, thereby stabilizing a shape of the glass fiber G1. In the present embodiment, helium gas having high thermal conductivity is used as the cooling gas. Since helium has high thermal conductivity, helium is suitable for use as the purge gas in the heating furnace 13 or a cooling solvent of the cooling device 19. However, since helium is higher in cost than nitrogen, nitrogen may be used instead of helium when importance is placed on cost. For example, a helium gas can be used during normal operation, and a nitrogen gas can be supplied to the heating furnace 13 instead of the helium gas after the drawing end.

An upper shutter capable of opening and closing an inlet of the insertion hole is provided at an upper end of the cooling device 19, and a lower shutter capable of opening and closing an outlet of the insertion hole is provided at a lower end of the cooling device 19. The upper shutter and the lower shutter are closed at the time of drawing, and the cooling efficiency of the cooling device 6 can be increased. Further, a small-diameter hole is formed at a center of the upper shutter and the lower shutter in a closed state. The small-diameter hole has a diameter slightly larger than that of the drawn glass fiber G1. The glass fiber G1 passes through the small-diameter hole while maintaining a slight clearance with the upper shutter and the lower shutter. A plurality of cooling devices 19 may be provided in series on a pass line.

Although not particularly limited, the outer diameter measuring device 20 of, for example, a laser light type is provided downstream the cooling device 19. An outer diameter dimension of the glass fiber G1 from the cooling device 19 is measured by the outer diameter measuring device 20. Although not particularly limited, the measurement of the outer diameter of the glass fiber G1 can be performed in each of orthogonal axis directions on a plane orthogonal to an axis of the glass fiber G1 to improve the accuracy. The outer diameter measuring device 20 may be provided at a plurality of positions on the pass line. A measured value of the outer diameter of the glass fiber G1 measured by the outer diameter measuring device 20 is sent to the control device 50.

The die 21 for coating the glass fiber G1 with the ultraviolet curable resin and the ultraviolet irradiation device 24 for curing the coated ultraviolet curable resin are provided downstream the outer diameter measuring device 20. The ultraviolet irradiation device 24 is not particularly limited, but is configured to irradiate the optical fiber G2 coated with the resin by a multi-light UV lamp with the ultraviolet ray to cure the ultraviolet curable resin. The ultraviolet curable resin is applied by the die 21 around the glass fiber G1 cooled by the cooling device 19 and having a stable shape, and the applied resin is cured due to an ultraviolet curing reaction by the ultraviolet irradiation device 24 provided downstream the die 21, thereby obtaining an optical fiber around which the ultraviolet curable resin layer is uniformly provided.

Downstream the die 21, a receiving plate 23 is usually provided at a position away from the pass line. The receiving plate 23 is moved to a position immediately below the die 21 when the glass fiber G1 or the optical fiber G2 is broken, and can receive the ultraviolet curable resin when the ultraviolet curable resin overflows from the die 21. A cutter 22 is provided between the die 21 and the receiving plate 23. The cutter 22 can cleave the optical fiber G2 that has been drawn and coated with resin. The die 21, the cutter 22, and the receiving plate 23 are controlled according to respective control commands from the control device 50.

The optical fiber G2 on which the ultraviolet curable resin coating layer is formed is drawn into the capstan 40 via the guide roller 30. A predetermined tension is applied to the optical fiber G2 by capstan 40. The capstan 40 includes a capstan belt 42 wound around a plurality of rollers 41, and a capstan roller 32 in close contact with the capstan belt 42. The capstan 40 applies tension to the optical fiber G2 by sandwiching the optical fiber G2 between the capstan belt 42 and the capstan roller 32, and the optical fiber G2 is pulled downstream.

The tension meter 31 for measuring the tension of the optical fiber G2 is provided between the guide roller 30 and the capstan 40. A measured value of the tension of the optical fiber G2 measured by the tension meter 31 is sent to the control device 50. A rotation speed of the capstan 40 is controlled according to a control command from the control device 50 such that the measured value of the outer diameter measuring device 20 is a predetermined value.

A linear speed detector 25 is incorporated in the capstan 40, and the linear speed is measured based on the rotation speed of the capstan 40. Further, the linear speed detector 25 may be incorporated into the guide roller 30, a screening device 33, and the dancer roller 34. A measured value of the linear speed of the optical fiber G2 measured by the linear speed detector 25 is sent to the control device 50.

The screening device 33 for performing an intensity test on the optical fiber G2 is provided downstream the capstan 40. In the screening device 33, a predetermined tension is applied to the optical fiber G2, and an intensity test such as pulling or bending is performed to test whether the optical fiber G2 satisfies a desired intensity condition for the target specification. If the optical fiber G2 is not cleaved in this test, the optical fiber G2 is a non-defective product.

The non-defective optical fiber G2 is fed to the first winding-up bobbin 36 and the second winding-up bobbin 37 via the dancer roller 34. For example, the non-defective optical fiber G2 is wound around one of the first winding-up bobbin 36 and the second winding-up bobbin 37, and the defective optical fiber G2 drawn at the time of drawing end work is wound around the other. Although not particularly limited, it is assumed in the following description that a non-defective product is wound up by the first winding-up bobbin 36 and a defective product is wound up by the second winding-up bobbin 37. The dancer roller 34 is provided with a dancer roller measuring unit 35 configured to detect displacement of the dancer roller 34. A measured value of the displacement of dancer roller 34 detected by dancer roller measuring unit 35 is sent to control device 50. The first winding-up bobbin 36 and the second winding-up bobbin 37 are configured to control the winding-up of the optical fiber G2 according to a control command from the control device 50.

### Configuration of Control Device 50

Next, a configuration of the control device 50 will be described with reference to FIG. 2. FIG. 2 is a block diagram of the control device 50 in the optical fiber producing apparatus 10 in FIG. 1. The control device 50 includes a detection unit 60, a linear speed control unit 70, and a coating layer formation and cleaving control unit 80. The detection unit 60 includes detection means such as a base material feeding detection unit 61, a furnace core temperature detection unit 62, an outer diameter measuring unit 63, a linear speed detection unit 64, a tension detection unit 65, and a dancer roller displacement detection unit 67.

The measured values measured by the unit detector 51 of the optical fiber producing apparatus 10 are sent to the detection unit 60, and the measured values measured by the unit detector 51 are collected and calculated in the respective detection means of the detection unit 60, and are stored in a memory (not shown) so as to be used for control calculation in the linear speed control unit 70 and the coating layer formation and cleaving control unit 80. For example, the measured value from the base material feeding detector 12 is sent to the base material feeding detection unit 61, the measured value from the temperature detector 17 is sent to the furnace core temperature detection unit 62, the measured value from the outer diameter measuring device 20 is sent to the outer diameter measuring unit 63, the measured value from the linear speed detector 25 is sent to the linear speed detection unit 64, the measured value from the tension meter 31 is sent to the tension detection unit 65, and the measured value from the dancer roller measuring unit 35 is sent to the dancer roller displacement detection unit 67.

The linear speed control unit 70 includes control units such as a drawing end determination unit 71, a base material feeding control unit 72, a gas supply amount control unit 73, a heating element control unit 74, a capstan control unit 76, and a winding-up control unit 77. The linear speed control unit 70 is configured to determine a target value of the linear speed at which the optical fiber G2 is drawn, which is set according to a specification, producing conditions, and the like of the optical fiber G2. This target value is set as a constant value as to be described later. Then, the linear speed control unit 70 uses the collected and calculated measured values stored in the memory of the detection unit 60 to calculate control commands for controlling the unit control equipment 52 of the optical fiber producing apparatus 10 such that the linear speed at which the optical fiber G2 is drawn follows the target value, and sends the control commands to the unit control equipment 52.

The target specification of the optical fiber G2 to be produced is set by the target specification setting unit (not shown) of the control device 50. The unit control equipment 52 is controlled according to the control commands sent from the linear speed control unit 70, thereby the optical fiber G2 is produced through each producing step of the optical fiber producing apparatus 10 so as to have set target specifications. For example, the base material feeding control unit 72 sends a control command to the feeding device 11, the gas supply amount control unit 73 sends a control command to the gas supply unit 14, the heating element control unit 74 sends a control command to the heating element 15, the capstan control unit 76 sends a control command to the capstan 40, the winding-up control unit 77 sends control commands to the first winding-up bobbin 36 and the second winding-up bobbin 37, thereby each control unit of the linear speed control unit 70 sends a control command to the unit control equipment 52 of the optical fiber producing apparatus 10 based on the measured values of the unit detector 51 detected by the detection unit 60 to control the unit control equipment, and thus each step of the optical fiber producing apparatus 10 is controlled to produce the optical fiber G2.

More specifically, the measured value of the outer diameter of the optical fiber G1 measured by the outer diameter measuring device 20 is acquired by the outer diameter measuring unit 63, and a command value of the rotation speed of the capstan 40 is calculated in the capstan control unit 76 based on the measured value of the outer diameter of the optical fiber G1. The command value of the rotation speed of the capstan 40 is sent from the capstan control unit 76 to the capstan 40, and the rotation speed of the capstan 40 is controlled according to the command value.

The drawing end determination unit 71 determines whether to end the drawing of the optical fiber G2 according to a drawing end condition to be described later, and when it is determined to end the drawing, sends an end control signal for ending the drawing of the optical fiber G2 to each control unit including the base material feeding control unit 72, the gas supply amount control unit 73, the heating element control unit 74, the capstan control unit 76, the winding-up control unit 77, and the coating layer formation and cleaving control unit 80. When receiving the end control signal from the drawing end determination unit 71, each control unit calculates a control command for controlling the unit control equipments 52, 53 to end the drawing of the optical fiber G2, and the control command is sent to the unit control equipments 52, 53, and thereby a control is performed such that the unit control equipments 52, 53 end the drawing of the optical fiber G2.

The coating layer formation and cleaving control unit 80 includes a die control unit 81, a cutter control unit 82, a receiving plate control unit 83, and the like, and is configured to calculate command signals, that is to be sent to the die, the cutter, and the receiving plate 53, using the control signals from the linear speed control unit 70 and the collected and calculated measured values stored in the memory of the detection unit 60. The die control unit 81 is configured to send, to the die 21, for example, a command for changing an application amount of the ultraviolet curable resin applied around the glass fiber G1, specifically, a command for changing a temperature of the die 21, a supply pressure of the resin to be supplied to the die 21, or the like. The cutter control unit 82 is configured to send, for example, a control command for cleaving the optical fiber G2 to the cutter 22 when the drawing of the optical fiber G2 is ended. The receiving plate control unit 83 is configured to send, for example, a control command to the receiving plate 23 when the optical fiber G2 is cleaved by the cutter 22, and is configured to perform control to move the receiving plate 23 to be positioned below the die 21 when the optical fiber G2 is cleaved.

### Structure of Optical-Fiber Base Material

A structure of the optical-fiber base material G will be described with reference to FIG. 3. FIG. 3 is a schematic diagram of the optical-fiber base material G. When the optical-fiber base material G is drawn, an ineffective portion La having a length La from a position of a=0, which is a drawing start end of the optical-fiber base material G, to a position of a1 is drawn at a drawing start. Thereafter, the drawing is performed on an effective portion Lb, which is an effective part having a core C and to be a product, over a length Lb from the position of a1 to a position of a2. When the drawing of the effective portion Lb having the core C is ended, an ineffective portion Lc, which is not to be a product, is continuously drawn in a part having a length Lc from a2 to a3. Since viscosity may be high in the portion Lb where the core C is present, while the viscosity may be low in the portion Lc where the core C is not present, or conversely, the viscosity may be low in the portion Lb where the core C is present, while the viscosity may be high in the portion Lc where the core C is not present, a difference in glass viscosity may be large at a joint portion between a core glass of the effective portion Lb and a core glass of the ineffective portion Lc. As described above, when the difference in glass viscosity is large, the drawing linear speed may rapidly increase

### Regarding Linear Speed Control

A linear speed control will be described with reference to FIG. 4. FIG. 4 is a graph of a linear speed of the optical fiber. In FIG. 4, a vertical axis represents a linear speed V [m/min] of the optical fiber G2, and a horizontal axis represents a drawing distance L [km]. The drawing distance L corresponds to a length of the optical fiber G2 wound up by the capstan 40, and is a numerical value obtained by, for example, calculating the number of rotations of the capstan 40 or time-integrating the measured value of the linear speed detector 25. A solid line is a graph when a drawing stop control is performed by the drawing end determination unit 71 of the present embodiment, and a two-dot chain line is a graph of a comparative example in which the drawing stop control is not performed by the drawing end determination unit 71 of the present embodiment

When the optical-fiber base material G is drawn by the optical fiber producing apparatus 10 of the present embodiment, from L=0 to L=L1 at the drawing start, the ineffective portion La at the drawing start end of the optical-fiber base material G is drawn, and during this time, the drawing speed is gradually increased. FIG. 4 shows that the linear speed V increases linearly, but a characteristic of the speed increase is not limited to a linear increase, and for example, an acceleration may gradually increase at first, then be constant, and then gradually decrease near L1.

From L1 to L2, a target value Vc of the linear speed V is controlled to be constant. Before al of the optical-fiber base material G is drawn, the linear speed V is stabilized and becomes substantially constant at the target value Vc. Between L1 and L2, the effective portion Lb having the core C of the optical-fiber base material G is drawn. Between L1 to L2, at least one of the feeding amount of the optical-fiber base material G, the output of the heating element 15 of the heating furnace 13 configured to heat the optical-fiber base material G, the speed of the capstan 40, and the speed of the first winding-up bobbin 36 or the second winding-up bobbin 37 is controlled by a corresponding one of the control units 72 to 77 of the linear speed control unit 70, in order to make the linear speed V match the constant target value Vc. Each control equipment can be controlled stably, for example, the rotation speed of the capstan 40 is controlled according to the control command from the control device 50 such that the measured value of the outer diameter measuring device 20 is a predetermined value. Further, the feeding device 11 is controlled to increase the feeding amount when the linear speed V is low, and to decrease the feeding amount when the linear speed V is high. Further, the heating element 15 of the heating furnace 13 is controlled to increase the output when the linear speed V is low; and to decrease the output when the linear speed V is high. However, since it is desirable to control the temperature of the heating furnace 13 to be as constant as possible, a control is performed to prioritize stabilization of the temperature in order to keep the linear speed V constant. In this way, the linear speed V of the optical fiber G2 is controlled to be kept constant at the target value Vc by stably controlling the unit control equipment 52. Under the control of the linear speed control unit 70, a fluctuation of the linear speed V of the optical fiber G2 is controlled within a range of less than 0.5% of the target value Vc with respect to the target value Vc between L1 and L2.

FIG. 4 shows an example in which the target value Vc of the linear speed V is always constant between L1 to L2, but the target value Vc of the linear speed V can also be changed as the producing conditions of the producing step of the optical fiber G2 are changed in the middle of producing. When the target value Vc of the linear speed V is changed to, for example, Vc′, the linear speed V is controlled to follow the target value Vc′ after the change, and the fluctuation of the linear speed V is controlled within a range less than 0.5% of the target value Vc′ with respect to the target value Vc′.

Between L2 and L3, when a drawing position of the optical-fiber base material G approaches an end portion of the effective portion Lb, that is, a position of the length a2, the target value Vc of the linear speed V remains constant, but the linear speed V cannot follow the constant target value Vc, and the linear speed V gradually decreases after L2. This is because, when the remaining amount of the optical-fiber base material G is reduced, an amount of glass supplied for drawing is relatively reduced, and therefore, after L2, the amount of glass is less than an amount of glass required to cause the linear speed V to follow the target value Vc, and the linear speed V decreases. FIG. 4 shows an example in which the linear speed V decreases linearly from L2 to L3, but the present embodiment is not limited thereto, and a characteristic of the decrease in the linear speed V changes depending on the producing conditions or the specifications of the optical fiber G2 to be produced, and for example, the linear speed V may gradually decrease more smoothly in a curved shape instead of the graph changing in a bent shape at L2.

At L3, the linear speed V reaches a reference linear speed Vs which is a condition for determining the drawing end defined in the present embodiment. In the graph of the comparative example indicated by the two-dot chain line in FIG. 4, the linear speed V continuously decreases from L2 to L5 and becomes lower than the reference linear speed Vs. At L5, the linear speed V rapidly increases and decreases. This is because, at a position of the length a2 at which the drawing position of the optical-fiber base material G is switched from the effective portion Lb having the core C to the ineffective portion Lc, the difference in the glass viscosity occurs at the joint portion between the core glass of the effective portion Lb and the core glass of the ineffective portion Lc. Then, after L6, the linear speed V rapidly increases because the glass viscosity decreases.

In the method for producing an optical fiber according to the present embodiment, a rapid increase and decrease of the linear speed V at L5 and a rapid increase of the linear speed V after L6 as in the comparative example are avoided and a stable linear speed control is realized even at the drawing end.

In the method for producing an optical fiber of the present embodiment, as in the graph of the solid line in FIG. 4, at L3, when the linear speed V reaches the reference linear speed Vs which is the condition for determining the drawing end defined in the present embodiment, the drawing end determination unit 71 determines that the drawing end position is reached, and transmits the control command for the drawing end process to each of the control units 72 to 77. The reference linear speed Vs is set to a low linear speed in a range of 0.5% or more and 3% or less with respect to the normal target value Vc, for example, a range of 0.8% or more and 1.5% or less, and preferably, for example, 1%. This is because the fluctuation of the linear speed V of the optical fiber G2 is usually controlled to be within a range of less than 0.5% of the target value Vc with respect to the target value Vc between L1 and L2, under the control of the linear speed control unit 70. Depending on the specifications of the optical fiber to be produced, the producing conditions, and the producing apparatus, it is also assumed that a fluctuation range of the linear speed V is slightly larger than 0.5%. for example, about 0.7%. Meanwhile, since the decreased linear speed V may rapidly increase when the drawing position is in the vicinity of the length a2 of the optical-fiber base material G, in order to realize the stable linear speed control, the reference linear speed Vs is set to be lower than the target value Vc within a range not exceeding 3% of Vc, for example, within a range not exceeding 1.5%.

At L3, when the linear speed V reaches the reference linear speed Vs, the drawing end determination unit 71 determines that the drawing end position is reached, and the drawing end determination unit 71 transmits the control command for the drawing end process to each of the control units 72 to 77 in a predetermined order. When receiving the control command for the drawing end process from drawing end determination unit 71, each of control units 72 to 77 sends the control command for a drawing end process to the unit control equipment 52. A time from when the drawing end determination unit 71 determines that the determination condition for the drawing end position at which the linear speed V has reached the reference linear speed Vs is satisfied to when the control command for the drawing end process is issued is appropriately determined according to the specifications of the optical fiber to be produced, the producing conditions, the producing apparatus, and the like, and may be the same time as, or may be a fixed time, for example, about 30 seconds to 60 seconds after the determination that the determination condition for the drawing end position is satisfied.

In the drawing end process, first, the winding performed by the first winding-up bobbin 36 for winding up the non-defective product is switched to the winding performed by the second winding-up bobbin 37 for winding up the defective product according to the control command of the winding-up control unit 77. Next, the rotation speed of the capstan 40 is gradually decreased according to the control command from the capstan control unit 76, and a thickness of the ultraviolet curable resin coated on the optical fiber G1 is gradually reduced according to the control command from the die control unit 81. Next, the gas supply unit 14 switches the purge gas from the helium gas to the nitrogen gas according to the control command from the gas supply amount control unit 73, the output of the heating element 15 is gradually decreased according to the control command from the heating element control unit 74, and the temperature in the furnace core tube 16 of the heating furnace 13 gradually decreases. In response to this, the feeding amount of the optical-fiber base material G is adjusted, according to the control command from the base material feeding control unit 72, to gradually decrease the linear speed V.

When the supply amount of the ultraviolet curable resin is sufficiently reduced according to the control command from the die control unit 81, the uncured ultraviolet curable resin does not fall down from the die 21, and the linear speed V of the optical fiber G2 is equal to or lower than the predetermined linear speed, the cutter 22 cleaves the optical fiber G2 according to the control command from the cutter control unit 82. Next, the receiving plate control unit 83 moves the receiving plate 23 to a position at which the receiving plate 23 can receive the uncured ultraviolet curable resin when the uncured ultraviolet curable resin falls down from the die 21 after the optical fiber G2 is cleaved. When the cleaved optical fiber G2 is wound up by the second winding-up bobbin 37 for winding up the defective product. the second winding-up bobbin 37 is stopped in response to the control command from the winding-up control unit 77, thereby ending the drawing end process. Accordingly, the linear speed V of the optical fiber G2 in the drawing end process is gradually decreased in a state of being stably controlled from Vs to 0 between L3 and L4. In FIG. 4, a slope of the linear speed V between L3 to L4 is shown as being constant, but is an example, the linear speed V does not need to decrease linearly in practice, and the linear speed V may be changed at a time point of L3 to draw a smooth curve, or may be a graph in which the deceleration of the linear speed V gradually decreases.

According to the method for producing an optical fiber of the present embodiment, it is possible to quickly determine that the effective portion Lb of the optical-fiber base material G is switched to the ineffective portion Lc, and to prevent the linear speed V from continuously increasing rapidly even at the drawing end of the optical fiber Further, in the drawing step, by controlling at least one of the feeding amount of the optical-fiber base material G, the output of the heating element 15 of the heating furnace 13 that heats the optical-fiber base material G, the speed of the capstan 40, or the speed of the winding-up bobbins 36, 37, the linear speed V for drawing the optical fiber at the winding-up bobbin is controlled by keeping the target value Vc of the linear speed V constant, and therefore, the linear speed V for drawing the optical fiber in the effective portion Lb of the optical-fiber base material G is stabilized following the constant target value Vc, so that a decrease in the linear speed V at the drawing end can be reliably detected, and the drawing end can be more accurately determined. Further, since a predetermined decrease amount of the linear speed V for determining the drawing end of the optical fiber in the drawing end determination step is set between 0.5% to 3% of the target value Vc, a range for setting the predetermined decrease amount of the linear speed V for determining the drawing end of the optical fiber with respect to the constant target value Vc of the linear speed V for drawing the optical fiber in the effective portion Lb of the optical-fiber base material G can specified, and the condition for determining the drawing end is appropriately set. Further, by setting an upper limit and a lower limit of the predetermined decrease amount of the linear speed V for determining the drawing end of the optical fiber with respect to the constant target value Vc of the linear speed V for drawing the optical fiber in the effective portion Lb of the optical-fiber base material G, erroneous setting when the condition for determining the drawing end is set can be prevented.

### Embodiment 2

A method for producing an optical fiber according to Embodiment 2 of the present disclosure will be described. In FIGS. 1 to 4, reference is made in common with Embodiment 1. In Embodiment 1, the condition for determining the drawing end position by the drawing end determination unit 71 has been described to be that the linear speed V of the optical fiber G2 decreases to the reference linear speed Vs, but in the present embodiment, an embodiment in which the condition for determining the drawing end position by the drawing end determination unit 71 is further added will be described.

In an actual producing apparatus, it is also assumed that various noises may be

generated depending on specifications of the optical fiber G2 to be produced, the producing conditions, and the producing apparatus. In the present embodiment, in order to prevent the drawing end determination unit 71 from erroneously determining that the drawing end position is reached even when the linear speed V of the optical fiber G2 temporarily decreases to the reference linear speed Vs or lower due to such noises, a plurality of determination criteria are provided, and the drawing end determination unit 71 correctly determines that the drawing end position is reached when all of the plurality of determination criteria are satisfied.

A first determination condition is that the linear speed V of the optical fiber G2 decreases to the reference linear speed Vs or lower as in Embodiment 1.

A second determination condition is that a remaining amount of the optical-fiber base material G detected by the base material feeding detector 12 decreases to Ls or less. Here, Ls=Lc+ΔL(ΔL≥0) . . . (Formula 1). In Formula 1, ΔL is a positive real number corresponding to a margin of a remaining amount of the effective portion Lb from a2, which is a position between the effective portion Lb where the core C is present and the ineffective portion Lc.

In the present embodiment, when both the first determination condition and the second determination condition are satisfied, the drawing end determination unit 71 determines that the drawing end position is reached. Accordingly, in the present embodiment, even when the first determination condition that the linear speed V of the optical fiber G2 is temporarily decreased to the reference linear speed Vs or lower due to noise or erroneous detection of the linear speed detector 25 is satisfied, when the second condition that the remaining amount of the optical-fiber base material G is decreased to Ls or less is not satisfied, the drawing end determination unit 71 does not determine that the drawing end position is reached, and thus erroneous determination of the drawing end position due to noise or the like can be prevented.

In the present embodiment, a third determination condition can also be further added. The third determination condition is that a length of the optical fiber G2 wound by the capstan 40, that is, a drawing distance L reaches a reference length LG. LG is calculated based on a volume of glass of the optical-fiber base material G from a tip end a=0 of the optical-fiber base material G to an ending position a2 of the effective portion Lb including the core C, an outer diameter of the optical fiber G2, and a predetermined margin base material glass amount.

When the first determination condition, the second determination condition, and the third determination condition are used, and all of the first determination condition, the second determination condition, and the third determination condition are satisfied, the drawing end determination unit 71 determines that the drawing end position is reached. A margin may be set in a detection signal of the base material feeding detector 12 in order to detect early that the remaining amount of the optical-fiber base material G becomes smaller than a predetermined amount. In such a case, the third determination condition is added in the present embodiment, therefore, even when the first determination condition that the linear speed V of the optical fiber G2 is temporarily decreased to the reference linear speed Vs or lower due to noise or erroneous detection of the linear speed detector 25 is satisfied, and the second determination condition is satisfied early because the margin is set in the detection signal of the base material feeding detector 12, the drawing end determination unit 71 does not determine that the drawing end position is reached when the third condition that the drawing distance L of the optical fiber G2 reaches the reference length LG is not satisfied, and thus erroneous determination of the drawing end position due to noise or detected margin can also be prevented. In the present embodiment, similarly to Embodiment 1, as shown in FIG. 4. the linear speed V of the optical fiber G2 in the drawing end process is gradually decreased in a state of being stably controlled from Vs to 0 between L3 and L4. Accordingly, according to the method for producing an optical fiber of the present embodiment, since it is possible to more reliably determine that the effective portion Lb of the optical-fiber base material G is switched to the ineffective portion Lc, the drawing can be performed at the stable linear speed V even at the drawing end of the optical fiber, and it is possible to more accurately grasp when the effective portion Lb of the optical-fiber base material G is switched to the ineffective portion Lc, without being affected by noise or the like, so that core glass of the effective portion of the optical-fiber base material G can be used up without waste.

### Embodiment 3

A method for producing an optical fiber according to Embodiment 3 of the present disclosure will be described In FIGS. 1 to 4, reference is made in common to Embodiments 1 and 2. In Embodiment 1, when the linear speed V reaches the reference linear speed Vs, the drawing end determination unit 71 determines that the drawing end position is reached, and the drawing end determination unit 71 transmits the control command for the drawing end process to each of the control units 72 to 77 in a predetermined order, but in the present embodiment, the reference linear speed Vs is determined based on historical data of past drawing of the optical-fiber base material G.

When the optical fiber G2 is drawn from the optical-fiber base material G, depending on specifications of the optical fiber G2, producing conditions, and a producing apparatus, regarding a boundary portion between the effective portion Lb having the core C of the optical-fiber base material G and the ineffective portion Le having no core C, a value of a distance L3 to be the determination condition for the drawing distance L, and a value of the linear speed V of the optical fiber G2 corresponding to the reference linear speed Vs to be the determination criteria when the drawing distance L is L3 are measured, and histories thereof are stored in a memory (not shown) of the linear speed control unit 70.

The optical fiber G2 wound around the winding-up bobbin is subjected to measurement of transmission characteristics such as transmission loss, wavelength dispersion, cutoff wavelength, mode field diameter, and polarization mode dispersion in a subsequent inspection step, and is distinguished as a non-defective product when the characteristics satisfy required specifications and a defective product when the characteristics do not satisfy the required specifications. The non-defective product and defective product determination data are stored in a memory (not shown) of the detection unit 60 together with the data of the drawing distance L.

Based on the drawing distance L3, in which the optical fiber G2 is drawn from the optical-fiber base material G, of a plurality of times in the past stored in the memory of the detection unit 60 and the data of the corresponding reference linear speed Vs serving as the determination criteria, the reference linear speed Vs corresponding to L3 serving as the drawing end determination condition and used for drawing the optical fiber G2 of target specifications from the optical-fiber base material G of this time is calculated by statistical processing.

In the statistical processing in this case, it is desirable to consider various conditions such as the specifications of the optical-fiber base material G and the optical fiber G2, the producing conditions. and the producing apparatus. Although not particularly limited, for example, the reference linear speed Vs corresponding to L3 serving as the drawing end determination condition is calculated by taking an average value of only past history information in which the specifications and producing conditions of the optical-fiber base material G and the optical fiber G2 are the same or satisfy a condition of being close to a predetermined range. For example, the reference linear speed Vs is obtained based on a linear speed decrease amount corresponding to the drawing distance at the boundary portion between the effective portion Lb and the ineffective portion Le of the optical-fiber base material G. Further, the reference linear speed Vs is obtained based on a linear speed decrease amount corresponding to the drawing distance at a boundary portion between the non-defective product and the defective product of the optical fiber G2.

Therefore, according to the method for producing an optical fiber of the present embodiment, it is possible to determine the drawing end accurately according to the specifications of the optical fiber producing apparatus 10 to be used, the specifications of the optical fiber, various producing conditions, and the like by using the reference linear speed Vs which is calculated based on the past history and servers as a condition for the drawing end in the drawing end determination unit 71 when the optical fiber G2 of the target specifications is drawn this time from the optical-fiber base material G. Accordingly, the drawing end can be determined more reliably, more accurately, and more stably.

Although the embodiments of the present disclosure have been described above, the present disclosure is not limited thereto. In addition, elements included in the embodiments described above can be combined as long as it is technical possible, and a combination thereof is also included in the scope of the present disclosure as long as the features of the present disclosure are included.

### REFERENCE SIGNS LIST

10: optical fiber producing apparatus
11: feeding device
12: base material feeding detector
13: heating furnace
14: gas supply unit
15: heating element
16: furnace core tube
17: temperature detector
19: cooling device
20: outer diameter measuring device
21: die
22: cutter
23: receiving plate
24: ultraviolet irradiation device
25: linear speed detector
30: guide roller
31: tension meter
32: capstan roller
33: screening device
34: dancer roller
35: dancer roller measuring unit
36: first winding-up bobbin
37: second winding-up bobbin
40: capstan
41: roller
42: capstan belt
50: control device
51: unit detector
52: unit control equipment
53: die, cutter, and receiving plate
60: detection unit
61: base material feeding detection unit
62: furnace core temperature detection unit
63: outer diameter measuring unit
64: linear speed detection unit
65: tension detection unit
66: optical fiber intensity detection unit
67: dancer roller displacement detection unit
70: detection unit
71: drawing end determination unit
72: base material feeding control unit
73: gas supply amount control unit
74: heating element control unit
76: capstan control unit
77: winding-up control unit
80: coating layer formation and cleaving control unit
81: die control unit
82: cutter control unit
83: receiving plate control unit
C: core
G: optical-fiber base material
G1: glass fiber
G2: optical fiber
V: linear speed of optical fiber
Vc: target value of linear speed
Vs: reference value of linear speed
La: ineffective portion
Lb: effective portion
Lc: ineffective portion
L: drawing distance

What is claimed is:

1. A method for producing an optical fiber, the method comprising:
drawing an optical-fiber base material while heating and softening the optical-fiber base material to produce a part of the optical fiber to be a product; and
determining whether a predetermined condition is satisfied to determine a drawing end of the optical fiber that is to be a product from the optical-fiber base material,
wherein, in the drawing, a linear speed for drawing the optical fiber is controlled with a target value of the linear speed constant, and
in the determining, when the linear speed is decreased by a predetermined amount from the target value, the drawing end of the optical fiber is determined.

2. The method for producing an optical fiber according to claim 1,
wherein the optical-fiber base material includes:
an effective portion that is a central portion in a longitudinal direction and that includes a core; and
an ineffective portion that is an end portion in the longitudinal direction and that includes no core, and
in the determining, the drawing end of the optical fiber is determined further in consideration of a remaining length of the effective portion of the optical-fiber base material.

3. The method for producing an optical fiber according to claim 1,
wherein, in the determining, a condition for determining the drawing end of the optical fiber is determined, based on a decrease amount of the linear speed of the optical-fiber base material drawn in the past and an inspection result of the optical fiber obtained from the optical-fiber base material.

4. The method for producing an optical fiber according to claim 1,
wherein, in the drawing, by controlling at least one of a feeding amount of the optical-fiber base material, an output of a heating element of a heating furnace for heating the optical-fiber base material, a speed of a capstan, or a speed of a winding-up bobbin, the linear speed for drawing the optical fiber at the winding-up bobbin is controlled with the target value of the linear speed constant.

5. The method for producing an optical fiber according to claims 1,
wherein the predetermined decrease amount of the linear speed for determining the drawing end of the optical fiber in the determining is set between 0.5% to 3% of the target value.
